(19) United States
(12) Patent Application Publication
(10) Pub. No.: US 2026/0046534 A1
(43) Pub. Date: Feb. 12, 2026

(54) IMAGE SENSOR

(71) Applicant: Taiwan Semiconductor Manufacturing Company, Ltd., Hsinchu (TW)

(72) Inventors: Chih-Min Liu, Hsinchu (TW); Shang-Fu Yeh, Hsinchu (TW); Hung-Yi TU, Hsinchu (TW); Calvin Yi-Ping Chao, Zhubei (TW)

(21) Appl. No.: 18/796,870

(22) Filed: Aug. 7, 2024

(51) Int. Cl. H04N 25/77; G01S 7/481; G01S 7/4865; G01S 17/894; H04N 25/131; H04N 25/76

(52) U.S. Cl. CPC H04N 25/77; G01S 7/4816; G01S 7/4865; G01S 17/894; H04N 25/131; H04N 25/7795

(57) ABSTRACT

A pixel of an image sensor includes a single photon avalanche detector (SPAD) and a counter circuit configured to selectively count pulses output by the SPAD based on detected photons in response to a recharge signal. A row select circuit is configured to selectively connect the SPAD to a time-to-digital (TDC) circuit in response to the recharge signal and a row select signal.

### BACKGROUND

Digital cameras and optical imaging devices employ image sensors. Image sensors convert optical images to digital data that may be represented as digital images. An image sensor typically includes an array of pixel sensors, which are unit devices for the conversion of an optical image into electrical signals. Such pixel sensors may employ avalanche photodiodes (APD), which are solid devices that are compatible with traditional CMOS devices. An avalanche process can be triggered when a reverse biased p-n junction receives additional carriers, such as carriers generated by incident radiation. For example, in order to detect radiations with low intensities, the p-n junction is biased above its breakdown voltage, thereby allowing a single photon-generated carrier to trigger an avalanche current that can be detected. Image sensor operated in this mode is known as a single photon avalanche diode (SPAD) image sensor, or a Geiger-mode avalanche photodiodes or G-APD.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 is a block diagram illustrating aspects of an image sensing system in accordance with some embodiments.

FIG. 2 is a schematic side sectional view of an example pixel of the image sensing system shown in FIG. 1, in accordance with some embodiments.

FIG. 3 is a schematic top view of the pixel shown in FIG. 2, in accordance with some embodiments.

FIG. 4 is a flow diagram illustrating an example of an imaging process in accordance with some embodiments.

FIG. 5 illustrates an example of a full frame 2D image having a target area identified thereon for 3D imaging in accordance with some embodiments.

FIG. 6 is a flow diagram illustrating an example of an imaging process in accordance with some embodiments.

FIG. 7 illustrates a 4D image before and after motion extraction processes in accordance with some embodiments.

FIG. 8 illustrates an example 2D image in which various objects are identified in accordance with some embodiments.

FIG. 9 is a block diagram illustrating further aspects of an imaging system in accordance with some embodiments.

FIG. 10 is a schematic diagram illustrating an example of a pixel circuit in accordance with some assignments.

FIG. 11 is a timing diagram illustrating aspects of the operation of the pixel circuit shown in FIG. 10, in accordance with some embodiments.

FIG. 12 is a timing diagram illustrating aspects of a 2D/3D imaging process for a global image frame in accordance with some embodiments.

FIG. 13 is a timing diagram illustrating additional aspects of the diagram shown in FIG. 12 in accordance with some embodiments.

FIG. 14 is a schematic diagram illustrating aspects of an example pixel matrix in accordance with some embodiments.

FIG. 15 is a schematic diagram illustrating aspects of a charge sum and compare circuit in accordance with embodiments.

FIG. 16 is a time diagram illustrating examples of operation of the circuit shown in FIGS. 14 and 15 in accordance with some embodiments.

FIG. 17 is a schematic diagram illustrating and example of a decide circuit in accordance with some embodiments.

FIG. 18 conceptually illustrates SPAD an example of dark count triggering.

FIG. 19 illustrates an example 2D image and corresponding 3D depth image in accordance with some embodiments.

FIG. 20 is a schematic diagram illustrating aspects of a delay circuit and a pixel recharge circuit in accordance with some embodiments.

FIG. 21 is a timing diagram illustrating aspects of operation of the circuit shown in FIG. 20 in accordance with some embodiments.

FIG. 22 is a schematic diagram illustrating an example of a TDC assist circuit in accordance with some monuments.

FIG. 23 is a schematic diagram illustrating aspects of an example counter circuit for an imaging pixel and according to some embodiments.

FIG. 24 illustrates aspects of operation of the counter circuit shown in FIG. 23.

FIG. 25 is a schematic diagram illustrating an example of a clamping circuit in accordance with some embodiments.

FIG. 26 is a schematic diagram illustrating another example of a clamping circuit in accordance with embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Image sensors convert optical images to digital data that may be represented as digital images. An image sensor typically includes an array of pixel sensors, which are unit devices for the conversion of an optical image into electrical signals. Pixel sensors sometimes use charge-coupled devices (CCDs) or complementary metal oxide semiconductor (CMOS) devices. Avalanche photodiodes (APD) are devices that are compatible with traditional CMOS devices. An avalanche process can be triggered when a reverse biased p-n junction receives additional carriers, such as carriers generated by incident radiation. For example, in order to detect radiations with low intensities, the p-n junction is biased above its breakdown voltage, thereby allowing a single photon-generated carrier to trigger an avalanche current that can be detected. Image sensor operated in this mode is known as a single photon avalanche diode (SPAD) image sensor, or a Geiger-mode avalanche photodiodes or G-APD.

Some image sensing devices and systems discussed and disclosed herein employ single photon avalanche diode (SPAD) image sensors, which can detect incident radiation with very low intensities (e.g., a single photon). SPAD image sensors are capable of capturing image information with exceptional sensitivity and precision, which is useful for 2D and 3D image applications such as autonomous vehicles, robotics, medical imaging, virtual reality, etc.

SPAD image sensing devices include an array of pixels, where each pixel acts independently as a photon detector. When photons of light strike the sensor, the SPAD pixels detect and count the number of photons that hit them. This information is then used to create a grayscale or color image, representing the two-dimensional spatial information of the scene.

In color 2D imaging using SPAD technology, additional steps are taken to capture the color information of the scene accurately. A color SPAD image sensor incorporates a color filter array (CFA), which is a pattern of color filters placed over the pixels. Examples of CFAs include the Bayer pattern, which has red, green, and blue (RGB) color filters arranged in a specific pattern. When light passes through the CFA, each pixel captures only a single color channel: red, green, or blue. The captured color information is then used to interpolate and reconstruct a full-color image. This is achieved by combining the intensity values of neighboring pixels with different color filters to estimate the missing color information. The result is a color 2D image that accurately represents the scene's color. Some embodiments disclosed herein further employ an infrared (IR) filter, as will be discussed further below.

SPAD image sensors are capable of capturing high resolution depth information used for 3D imaging. For 3D imaging, SPAD sensors employ ToF principles, where a sensor emits short pulses of light towards a scene by a full frame light source, a row scan light source, a single spot light source, or the like depending on the particular applications and distances, and the SPAD pixels detect the photons that are reflected back. The sensor measures the precise timing of the arrival of each photon, which corresponds to the distance traveled by the light.

By analyzing the time-of-flight of photons, the SPAD sensor can calculate the depth information for each pixel. The sensor generates a depth map, where each pixel represents the distance between the sensor and the object in the scene. This depth map, combined with the 2D image captured by the SPAD sensor, provides a comprehensive 3D representation of the scene.

SPAD sensors can detect even extremely low levels of light, down to the level of single photons. This makes them ideal for applications in low-light environments or scenarios where high sensitivity is required, such as in medical imaging or scientific research. Additionally, SPAD sensors offer ultra-fast response times. They can accurately measure the time-of-flight of photons with high precision. This enables high-speed imaging and real-time depth calculations, making SPAD technology suitable for applications that demand fast acquisition, such as robotics or autonomous vehicles.

In contrast, traditional image sensors such as four-transistor (4T) pinned photo diode CMOS image sensors convert light into charges on a capacitor and the resulting voltage is read out using analog circuits that may induce noise, which can make operation difficult in low light situations. SPAD sensors, however, have high photon detection efficiency, enabling them to detect even low levels of light. They also offer fast response times, capable of accurately measuring the time-of-flight of photons. This makes SPAD sensors desirable for use in low-light environments or high-speed imaging scenarios.

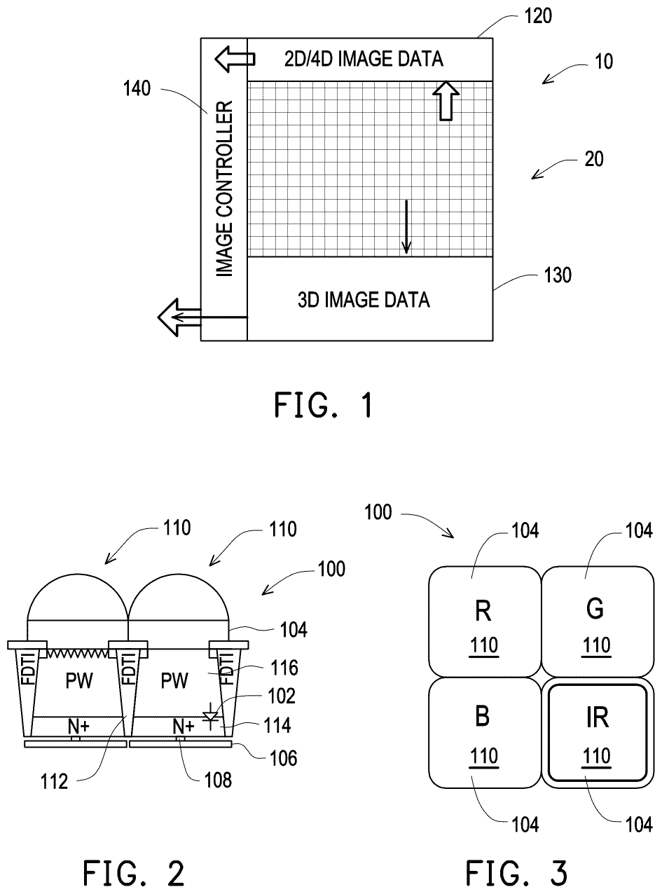

FIG. 1 illustrates aspects of an imaging system 10 in accordance with disclosed examples. The imaging system 10 has an array 20 of SPAD image sensors. Information obtained by the SPAD image sensor array 20 is output to a 2D/4D image processor 120 and a 3D image processor 130. The 2D/4D image processor 120 and 3D image processor 130 interact with an image controller 140, which combines the 2D/3D data from the 2D/4D image processor 120 and the 3D data from the 3D image processor 130. The 2D image processor includes, for example, a data shift circuit and a high dynamic range (HDR) data path. The 3D image processor includes, for example, a row-based or regional-based selector, spatial-temporal correlator, and single or multiple event time-to-digital (TDC) circuit that includes a ToF circuit.

In the illustrated example, the 2D/4D image processor 120 is shown located above the array 20 with the 3D image processor 130 below the array and the image controller 140 to the left of the array. In other embodiments these components may be arranged differently. The 2D/4D image processor 120, the 3D image processor 130, and the image controller 140 may be implemented by one or more processing systems, such as a central processing unit (CPU), graphics processing unit (GPU), neural processing unit (NPU), IA engine, etc.

FIG. 2 and FIG. 3 schematically illustrate aspects of an example SPAD image sensor 100 of the image sensor array 20. The sensor 100 is a color image sensor and includes four SPAD pixels 110 (two pixels are shown in the sectional side view of FIG. 2). A CFA 104, which is a pattern of color filters R, G, B and IR, is situated over respective individual pixels 110. When light passes through the CFA 104, each pixel captures only a single color channel: red, green, or blue. The illustrated CFA 104 shown in FIG. 2 and FIG. 3 further includes an IR filter, which will be discussed further below.

Each pixel 110 includes an n-type semiconductor region 114 and a p-type semiconductor region 116 formed inside a well layer of a substrate. The n-type semiconductor region 114 is made of, for example, silicon and is a semiconductor region in which a conductivity type having high impurity concentration is an n-type. The p-type semiconductor region 116 is a semiconductor region in which a conductivity type having high impurity concentration is a p-type.

The SPADs 102 are formed at a junction of the n-type semiconductor region 114 and p-type semiconductor region. The n-type semiconductor region 114 functions as a cathode of the SPAD 102. An anode opposite to the cathode is, for example, formed by the p-type semiconductor region 116. The SPAD 102 is connected to a conductive interconnect structure 106 via a backside conductive contact 108.

Separating regions 112 separate the SPADs 102 of adjacent pixels 110, and as such are provided on the sides of pixels 110. In some examples, the separating regions 112 include trenches formed between adjacent pixels 110. Some examples further include an insulating film such as an oxide film and/or a nitride film lining the trenches of the separating regions 112, with a light shielding material such as tungsten or aluminum filling the trenches. Note that an insulating film made of the same material as that of the insulating film may be used to integrally form the insulating film and the light-shielding part.

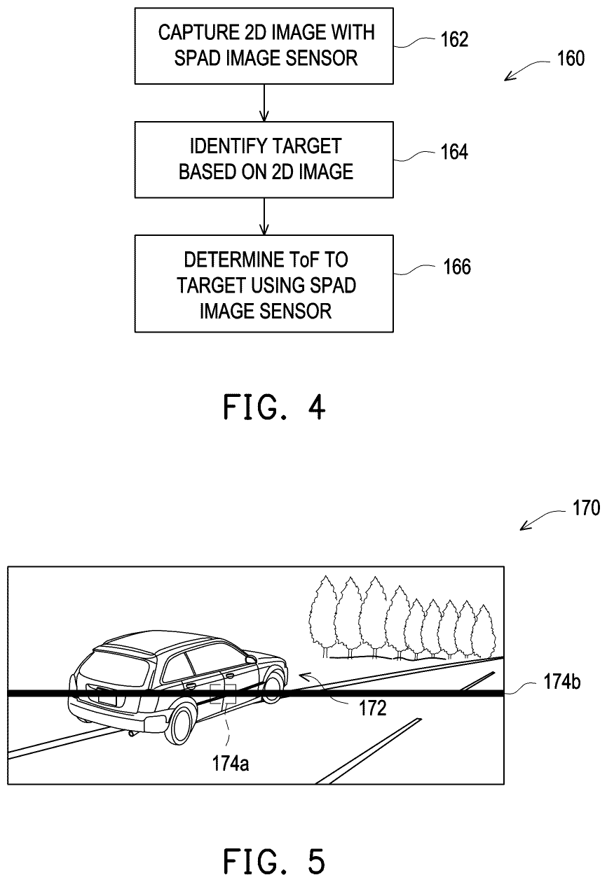

FIG. 4 is a flow diagram illustrating aspects of an image capture process in accordance with the present disclosure. The process 160 may be implemented by the system 10 shown in FIG. 1. The image capture process 160 is sometimes referred to herein as an “attention based” imaging process, which generates a full frame 2D image using the SPAD sensor array 20, while capturing 3D depth data for only a portion of the image.

In the process 160 shown in FIG. 4, a 2D image is captured by the image sensors 100 of the sensing array 20 in operation 162. As noted above, the image sensors 100 include SPAD pixels 110. An object is detected in the 2D image, such as by the image controller 140. Based on the detected object, a target is identified in the 2D image in operation 164. Rather than capturing 3D depth information for the entire 2D image, 3D depth data is captured by the image sensors 100 for only the target area by determining ToF to the target in operation 166.

More particularly, in some examples determining ToF in operation 166 includes emitting a plurality of light pulses toward the target by a light source of the imaging system 10. In some embodiments, the image sensor 10 further includes a light source configured to emit light pulses to an object such as the identified target. The light source could be a laser light source that emits laser pulses to the target, but the disclosure is not limited to any specific type of light source. In some examples, the light pulse is an IR light pulse and is detected by the pixel 110 associated with the IR filter 104. The IR filter 104, for example, may be a band pass filter configured to pass the desired IR frequencies or wavelengths. By using IR light pulses for obtaining 3D depth data, the system is safer for the human eye, and prevents or reduces visible light interference.

Photons reflected back from the target are detected by the sensing array of the sensing device, and a ToF value of the detected photons is determined. In some embodiments, the ToF value is calculated according to a reference time when the light pulses are emitted by the light source and an arrival time when the reflected light is received by the SPAD sensor 100. The ToF value is used to determine a distance from the SPAD sensor 100 to the target, and a depth results or a depth map of the target may be determined according to the distances from the sensor 100 to the target.

FIG. 5 shows an example full frame 2D image 170 captured by the image sensors 100 of the sensing array 20 in operation 162. The image data obtained by the sensors 100 are processed by the 2D image processor 120 and image controller 140. As shown in the example of FIG. 5, the 2D image 170 includes a vehicle 172. The image controller 140 may be configured to identify various items in the 2D image 170, such as the vehicle 172. Based on the 2D image 170, a target is identified, which is an area of the 2D image 170. In some examples, the target is a small area 174a of the 2D image 170, and in other examples the target is one or more rows 174b of the 2D image frame (the target area 174a and target row(s) 174b are referred to interchangeably herein as the target 174).

The sensors 100 then determine ToF to the target 174, and depth results or a depth map of the target 174 may be determined according to the distances from the sensor 100 to the target 174. In the example of FIG. 5, the target 174 is a small area of the identified object, i.e. an area of the vehicle 172. In other examples, the target area could be one or more rows of the array 20 such as one or more rows passing through the target 174 area shown in FIG. 5.

Various disclosed embodiments are configured such that the same SPAD image sensor is used for both the 2D and 3D data capture. Since one SPAD sensor 100 functions for both 2D and 3D data capture, the sensor can use a common lens, eliminating the need to align separate 2D and 3D lenses.

Generally, if one SPAD sensor array is used for a full frame ToF 3D image, performance efficiency can be low due to unnecessary information (like background objects) being collected, causing the frame rate to drop. As noted above, to capture 3D distance data, ToF is determined. Pulses of light are emitted towards the scene, and the SPAD pixels detect the photons that are reflected back. The timing of the arrival of each photon is determined, which corresponds to the distance traveled by the light. However, ambient light photons and “dark count” issues (discussed further below) can interfere with ToF measurement. To address this and other noise factors, histograms are commonly used to analyze and extract depth information from the captured data. Histograms provide a statistical representation of the ToF measurements, allowing for improved accuracy in the calculation of distance or depth values.

For the ToF calculations, the arrival time for each detected photon is considered relative to the start of the emitted light pulse. These arrival times are then used to create a histogram that represents the distribution of photon arrival times. Histogram bins are created based on the range of possible photon arrival times. The bins represent different time intervals or “time buckets” into which the arrival times are grouped. The number of photons falling within each bin is counted, resulting in a histogram that shows the distribution of photon counts as a function of arrival time. Peaks in the histogram correspond to objects or surfaces at different distances from the SPAD image detector. By analyzing the shape and characteristics of the histogram, it is possible to determine the depth information or distances to different objects in the scene. Constructing the histogram thus uses multiple samples, which can add considerable time to the 3D imaging process if performed for the entire image frame. Moreover, if detected objects are farther away, more samples are used for accurate calculations. This further impacts timing. By determining depth information for only the target area as discussed above, rather than for the entire 2D image frame, the imaging system efficiency is improved by reducing rows of processing and adaptively adjusting parameters of the 3D ToF histogram.

Since the process of obtaining the 2D data and constructing the image is faster, the 2D image is used in some implementations to identify aspects of the image, such as the vehicle 172, and the target 174. As such, aspects of the 2D image may be used to set parameters for obtaining 3D data.

In some examples, the 2D image is further enhanced by capturing a 4D image. As used herein, 4D refers to an additional dimension of time, and as used herein, a 4D image refers to a high frame rate 2D image capture.

In traditional 3D imaging, spatial information is captured and represented in three dimensions, typically with attributes such as width, height, and depth. This provides a static representation of an object or scene at a particular point in time. However, in 4D imaging, the additional dimension of time is incorporated, enabling the observation of changes and movements over time. Thus, 4D imaging allows for the capture and analysis of dynamic processes, such as motion. In some disclosed imaging processes, a 4D image is captured (i.e. a high framerate 2D image) using the SPAD array 20. At a very high framerate, a 2D image may be darker or otherwise less clear, but is otherwise generally low noise. This 4D image may be used to obtain a deblurred 2D image, and motion track target objects. Motion data may be extracted from the 4D image using appropriately programmed processors or AI systems. A 2D image may then be synthesized by accumulating 4D image data with motion compensation, resulting in a high dynamic range (HDR) image with the extracted motion data applied thereto.

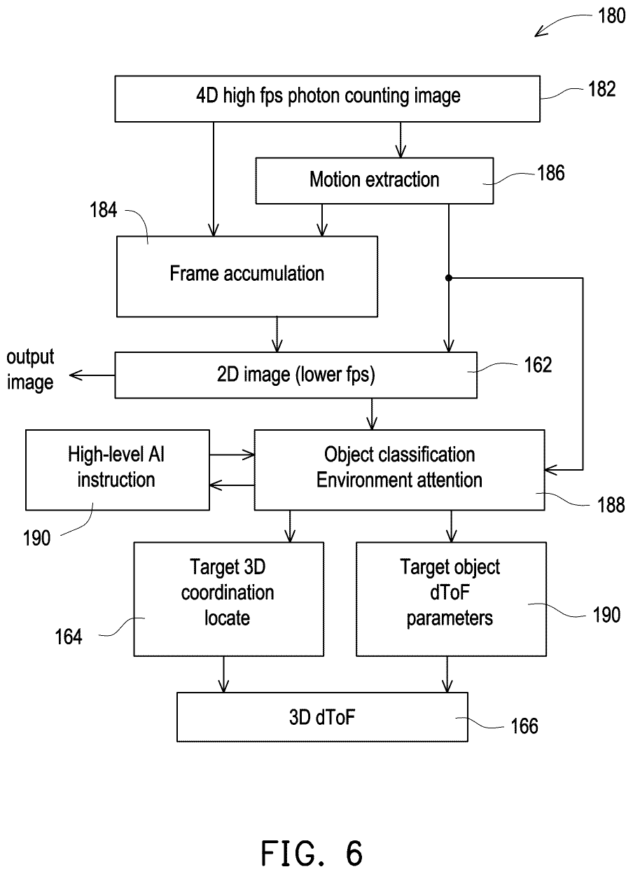

FIG. 6 illustrates further aspects of an image capture process 180. The image capture process 180 includes operations 162, 164 and 166 from the example shown in FIG. 4. More specifically, the image capture process 180 also includes capturing a 2D using the SPAD image sensor array 20 at the operation 162, identifying a target in the 2D image at operation 164, and determining 3D depth information of the target using ToF techniques.

The image capture process 180 includes capturing a 4D image using the SPAD image sensor array 20 at operation 182. As noted above, the captured 4D image is essentially a 2D image captured at a very high frame rate. As will be explained further below, in some examples the image at operation 182 is captured at a frame rate of over 2000 fps, though other frame rates are within the scope of the disclosure, and could vary depending on factors such as the size of the array 20. As with the 2D image captured in operation 162, the SPAD image sensors 100 in the array 20 function as photon detectors. When photons of light strike the sensors 100, they detect and count the number of photons that hit them. The captured 2D image frames are accumulated and combined at operation 184 to create the 2D image at operation 162, representing the two-dimensional spatial information of the scene.

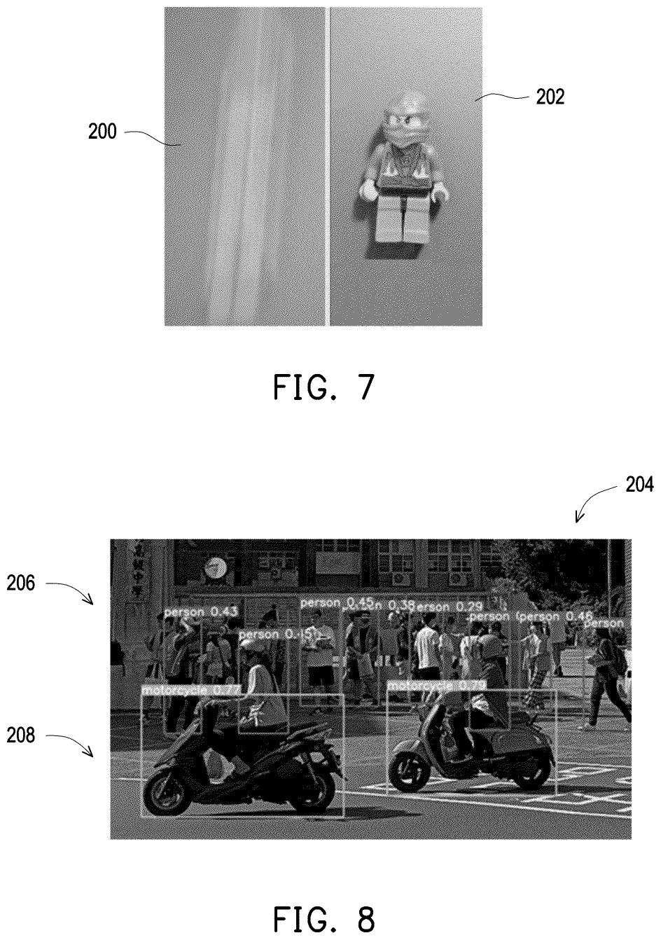

In the example shown in FIG. 6, motion is extracted from the 4D image at operation 186. Motion extraction involves detecting and extracting motion information from the image frames captured in operation 182. As noted above, at operation 182 a sequence of image frames are captured at high frame rates. Each frame represents the photon counts of the scene at a specific point in time. Moving objects are separated from the static background using background subtraction techniques, which may include comparing each image frame to a reference or background frame and subtracting the static parts to isolate the moving objects. FIG. 7 illustrates an example of a 4D image 200 captured at operation 182, and further illustrates the image 202 following the motion extraction process at operation 186. In the example of FIG. 7, the captured image depicts a moving object. The left side image 200 is blurry due to movement, and following the motion extraction 182, the right side image 202 is clear.

Once the moving objects have been separated from the background, individual objects may be identified and delineated within the image frames at operation 188 using known algorithms and AI processes 190, for example. FIG. 8 illustrates examples of identified objects in a captured image 204, including several people 206 and two motorcycles 208. Based on the object classification at operation 188, a target (such as the target 174 shown in FIG. 5) and its location in the 2D image is identified at operation 164, and ToF parameters are determined at operation 190. Such parameters determined in operation 190 could include, for example, lightness/darkness or near/far characteristics of the 2D image that could impact the ToF process parameters including pulse width, threshold, or histogram sample number decisions. For instance, in dark conditions additional samples could be necessary for constructing the histogram. At operation 166, ToF between the sensor 100 to the target 174 is determined to provide distance information.

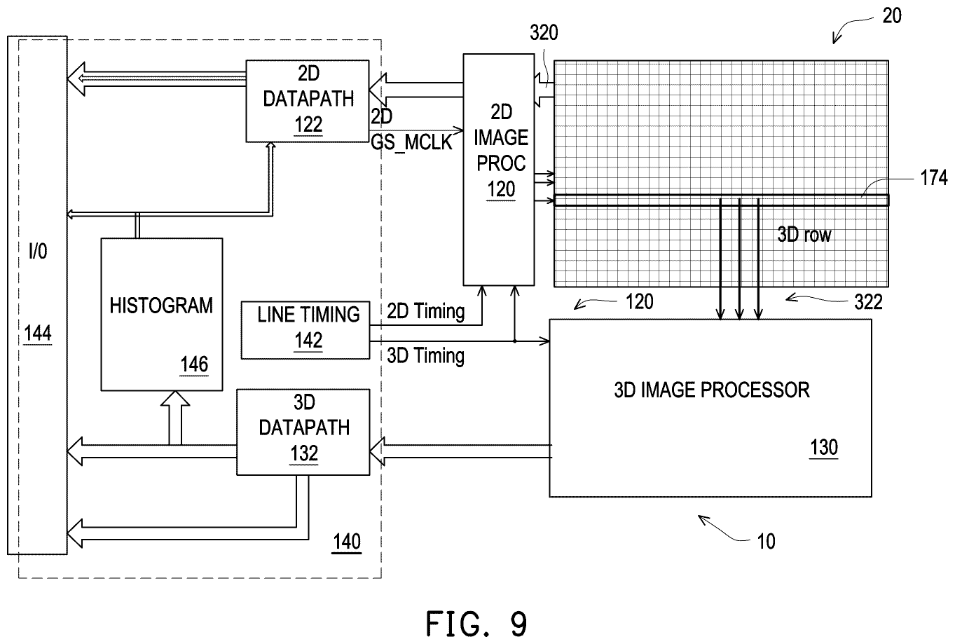

FIG. 9 is a block diagram illustrating further aspects of an example image sensor system 10 for implementing the process of FIG. 6. The system 10 includes the array 20 of SPAD image sensors, which output data to the 2D image processor and the 3D image processor 130. 2D and 3D data are output to a respective 2D data path 122 and a 3D data path 132 of the image processor 140.

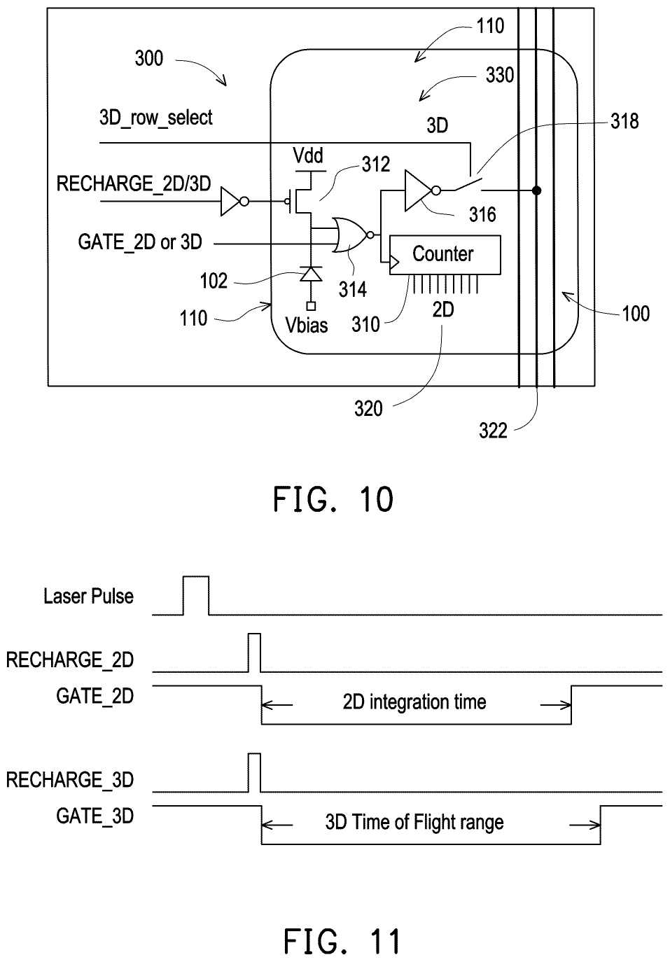

FIG. 10 shows further an example of the image sensor 100. As noted above, each pixel 110 of the image sensor 100 includes a SPAD 102, which is connected to a pixel control circuit 300. The pixel control circuit 300 includes a counter circuit 310 that is configured to count pulses output by the respective SPAD 102 based on detected photons. A control transistor 312 is connected between a cathode of the SPAD 102 and a first voltage terminal Vdd, and receives a recharge signal RECHARGE_2D/3D at its gate terminal. An anode of the SPAD 102 is connected to a bias terminal Vbias. In the illustrated example, the control transistor 312 is a PMOS transistor. The cathode of the SPAD 102 is further connected to an input of a NOR gate 314.

When the RECHARGE_2D (or 3D) signal is high, the SPAD 102 is recharged by the control transistor 312 to pull its reverse junction voltage higher than breakdown. When the RECHARGE_2D (or 3D) signal goes low, the control transistor 312 turns off as a large resistor but still keeps the diode in a heavily reversed status. When photons hit the SPAD 102, the diode junction goes into avalanche and generates a falling edge to the input of the NOR gate 314. The other input terminal of the NOR gate 314 is connected to a gating signal to gate the event so that later circuits can selectively ignore the output of the SPAD 102. Thus, the gating signal is low to sense the output of the SPAD 102, and high to selectively ignore (i.e. gate) the SPAD events. Using the RECHARGE 2D/3D and GATE 2D/3D signals in combination to define a 2D integration (collect photons) time, or 3D ToF time, determines whether the selected row is a 3D row or a normal row (other rows in 2D mode). For 2D image capture, a counter circuit 310 counts the number of photons that hit the SPAD 102. The output of the counter circuit 310 is connected to a 2D bus 320.

The pixel control circuit 300 further includes a row select circuit 330 configured to selectively connect the output of the SPAD 102 to a 3D bus 322 and a TDC of the 3D image processor in response to the SPAD enable signal and a 3D row select signal 3D_row_select. The TDC of the 3D image processor 130 includes a ToF circuit configured to determine ToF between the sensor 100 and the target.

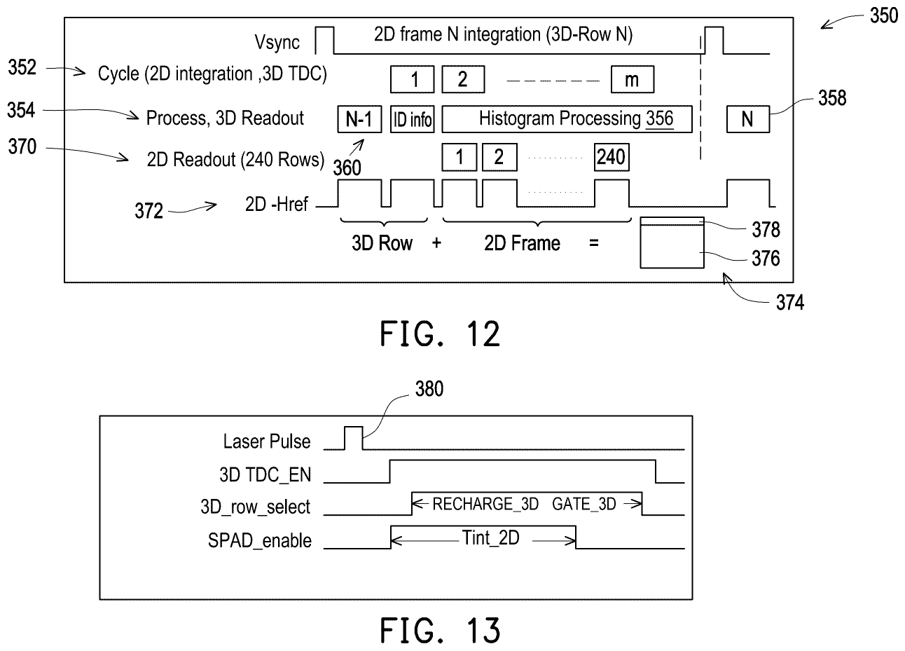

In some examples, image controller 140 includes a row decoder that outputs the 3D_row_select signal and the RECHARGE and GATE signals of FIG. 11 to select the 2D or 3D version of timing, in addition to providing row control for 2D image captures. As noted above, a target is identified in the captured 2D image. Rather than capturing 3D depth information for the entire 2D image, 3D depth data is captured by the image sensors 100 for only the target area by determining ToF to the target in operation 166. As noted above, in some examples, the target may comprise one or more rows of the array 20. Thus, For such a target row, the 3D_row_select signal is asserted to activate a row select switch 318 and connect the output of the SPAD 102 to the 3D bus. In the illustrated example, a buffer circuit 316, such as an inverter or buffer circuit, is connected between the NOR gate 314 and the row select switch 318.

Thus, in the 2D mode, the sensor 100 is configured to determine a count of photons detected by the SPAD 102. The counter 310 outputs this data to the 2D data bus for 2D image creation. Further, in some examples, for each 2D global shutter frame, 3D image data are determined for the target 174, which could be one row 174b. In other words, every 2D global shutter frame inserts one row for determining ToF data for 3D image data. This 3D image data is output to the 3D data bus 322.

FIG. 11 illustrates an example of a portion of a timing diagram for operation of the image sensor 100. A recharge pulse is asserted for each unit cycle. In some examples there are 128 cycles. For 3D mode operation (i.e. for a determined target row), the RECHARGE_3D signal goes high to connect the SPAD 102 output to the 3D data bus 322. For 2D operation, the 3D_row_select signal would stay low.

FIG. 9 shows 3D data collected in the target row 174 output on the 3D bus 322 to the 3D image processor 130 and a 3D data path 132 of the image controller 140. 2D data collected by the array 20 is output on the 2D data bus 320 to the 2D image processor 120 and a 2D data path 122 of the image controller 140. A line timing circuit 142 provides timing signals to the 2D image processor 120 and the 3D image processor 130. An I/O circuit 144 receives the 2D image information from the 2D data path 122 and the 3D image information from the 3D data path 132. As noted above, 3D data is further provided to a histogram circuit 146 for constructing the ToF histograms. Several samples of the ToF information is collected by the image sensors 100 of the array 20 for the target 174, and output to the 3D bus 322 to the 3D data path 132. These samples are used by the histogram circuit 146 to construct the histogram, which is output to the 2D data path 122 to be combined with the 2D image.

FIG. 12 is an example timing diagram illustrating aspects of the 2D and 3D imaging process for a global image frame. In the illustrated example the array 20 includes 240 rows and 324 columns. Each full frame output is signaled by a Vsync signal, and each full frame includes m cycles. In the illustrated example, for a given row N, 2D image data is integrated each cycle 1, 2, . . . m as shown in the second row 352 of the diagram 350. Further, for 3D imaging (i.e. for the target row 174b), the ToF information is repeated for each of the m cycles and the data is used to construct the histogram. The histogram processing 356 is shown in the third row 354 of the diagram, and the 3D output 358 for the row N (i.e. the target row 174b) is provided to the next cycle. 3D information 360 from a previous row N−1 is additionally provided, in addition to a second row providing related identifying information. Further, 2D data for the 240 rows (i.e. rows 1,2 . . . . N) of the array that were integrated in the previous cycle are shown in the fourth row 370 of the diagram. The last row 372 of the diagram shows the 3D information for the target row together with the 2D frame data. These data are combined, resulting in a full image frame 374, in which includes the 2D frame 376 together with two 3D rows 378.

FIG. 13 illustrates further details of each operation for each of the cycles 1,2 . . . m shown in row 352 of the diagram 350. Each cycle includes a light pulse 380, such as a laser pulse, being output. The TDC circuit of the 3D image data processor 130 is activated in response to a TDC enable signal TDC_EN to determine the elapsed time between emission of the light pulse 380 until the SPAD 102 senses the photons reflected back. For the target 3D row 174b, the 3D_row_select signal is asserted, and for the corresponding 2D row, the RECHARGE_2D signal is asserted. 2D data integration occurs while the RECHARGE_2D signal is asserted. Thus, the total integration time for the 2D is based on the number of frames, the number of cycles m, and the integration time Tint_2D for each frame, or Frames×m×Tint_2D.

The image controller 140 then combines the 3D rows 378 from each cycle m to provide the 3D target row information and the 2D frames 376 from each row are accumulated. The 2D and 3D image data may then be combined and output by the I/O circuit 144. In some implementations, the I/O circuit includes a two frame buffer for stitching the 3D frame data and accumulating the 2D frame data, and a frame grabber circuit combines the 3D stitched image and the 2D full frame image in a 3D/2D side-by-side image display. The frame buffer circuit may be implemented by an appropriately programmed FPGA, or any other suitable processor.

In the illustrated example, if the unit cycle time is 3.4 us with a global clock GClock speed of 512 MHZ, 1,728 GClock cycles are required to complete one cycle. 3D data generation uses m cycles to gather the ToF data and construct the histogram. As shown in FIG. 12 and FIG. 13, at the same time 2D frame data is generated and combined with the 3D row data. If 100 cycles are used (i.e. m=100), the frame time is 3.4 us*100 cycles=340 us, and the frame rate is 1/340 us or about 2900 fps. With this high frame rate (and short 2D integration time), the resulting 2D image may be dark, but photon info is collected. This high frame speed image (i.e. the 4D image) is then used for motion tracking and image deblur. The SPAD image sensors 100, which operate by photon counting, generally have little or no circuit noise issues. As such, the image frames can be accumulated (e.g. 290 frames into one), resulting in a slower frame rate (e.g. about 10 fps) with high dynamic 2D images.

As noted above, the SPAD image sensors 100 operate by detecting and counting the number of photons that hit them for 2D imaging, and for 3D imaging, by employing ToF principles, where a sensor emits short pulses of light towards a scene, and the SPAD pixels detect the photons that are reflected back. Besides photon-generated carriers, thermally-generated carriers (through generation-recombination processes within the semiconductor) can also fire the avalanche process in the SPAD pixels. Therefore, it is possible to observe output pulses when the SPAD is in complete darkness. The resulting average number of counts per second is called dark count rate (DCR) or dark noise, and is a parameter for defining the detector noise. Other factors, such as ambient light, can also interfere with photon timing for 3D imaging.

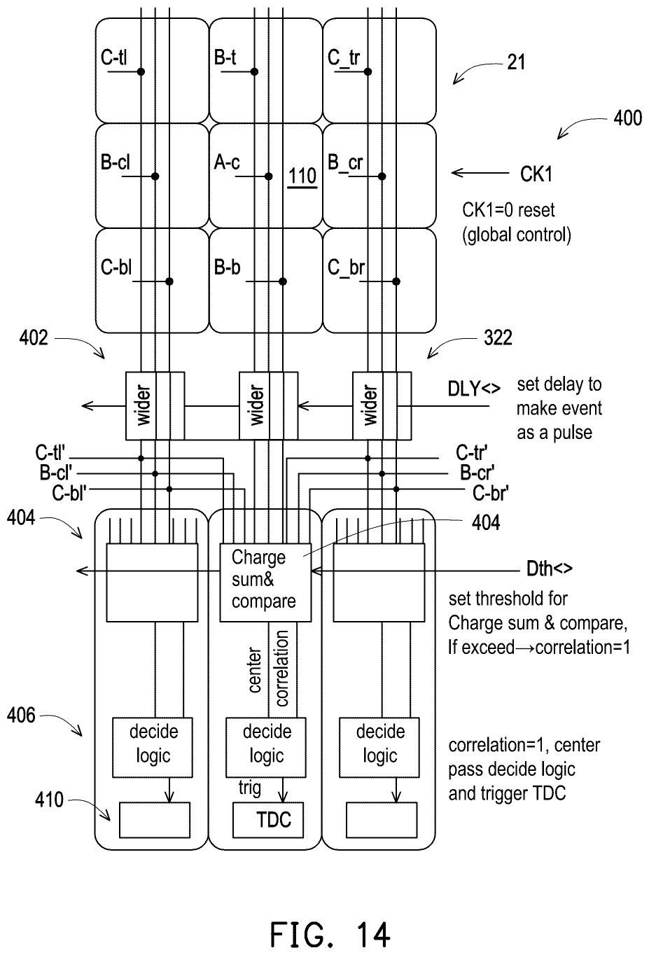

FIG. 14 illustrates an example of a charge sum and compare circuit 400 configured to address issues associated with dark noise and other such factors that could interfere with photon detection for determining ToF in the 3D imaging process. Thus, the circuit shown in FIG. 14 is implemented in the 3D data path 132 or the 3D control circuit 130 in some implementations. As noted above, thermally-generated carriers are generated by the SPAD semiconductor device itself. Accordingly, it is unlikely that multiple pixels in close proximation to one another would simultaneously experience this phenomenon. Conversely, it would not be unusual for more than one adjacent pixel to detect reflected protons.

To address dark noise and other noise issues, among other things, the circuit 400 of FIG. 14 is configured to check additional pixels in close proximity to a given pixel that goes into avalanche mode to verify that a detected photon caused the given pixel to trigger. Thus, in short, if the SPAD 102 of the given pixel triggers, the circuit 400 determines whether one or more additional pixels in close proximity to the given pixel also trigger before initiating the ToF determination of the TDC processor. In some examples, this is implemented by a charge sum process.

FIG. 14 illustrates a portion of the pixel array 20, including a 3×3 matrix 21 of nine of the SPAD pixels 110. In other embodiments, fewer or more than nine pixels may be used in different sized arrays (e.g. 5×5 matrix) depending on the complexity allowed or desired) to correlate the output of a given pixel. The center pixel 110 is designated pixel A-c in FIG. 14. The “neighboring” pixels are used in the determination whether to trigger the TDC process to determine ToF for 3D imaging. Pixels immediately adjacent to the center pixel A-c, i.e. those pixels immediately above, below, left and right of the center pixel A-c are respectively designated as B-t, B-b, B-l and B-r. Still further, the pixels diagonally adjacent to the center pixel A-c, i.e. top-left, top-right, bottom-left and bottom-right are respectfully designated as C-tl, C-tr, C-bl and C-br. Each of the illustrated pixels 110 are connected to the 3D data bus 322, and thus output a signal to the 3D bus 322 in response to the SPAD going into avalanche mode.

The circuit 400 includes delay circuits 402 connected to receive signals from the pixels 110. The delay circuits 402 are configured to turn the triggering event of the SPADs 102 (i.e. avalanche mode) into a pulse. These pulses are output to respective charge sum and compare circuits 404. Each of the charge sum and compare circuits 404 receive outputs of the pixels 110 of its respective column, as well as the columns on either side thereof. Thus, the charge sum and compare circuit 404 shown in the center column of FIG. 14 receives output pulses A-c′, B-t′ and B-b′ from the delay circuits of the center column, as well as the output pulses C-tl′, B-cl′ and C-bl′ of the pixels in the left column, and the output pulses C-tr′, B-cr′ and C-br′ of the pixels in the right column.

Referring back to FIG. 13, the 3D data path 132 is configured to determine the elapsed time between emission of the light pulse 380 until the SPAD 102 senses the photons reflected back. When the center pixel A-c triggers, the charge sum and compare circuit 404 determines whether enough of the additional pixels 110 of the matrix 21 have also triggered to correlate or verify the center pixel's A-c output. In the illustrated example, this is done via a charge sum and compare process.

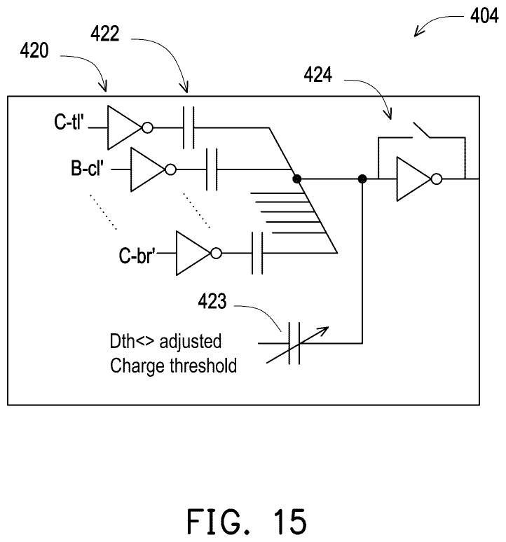

FIG. 15 illustrates an example of the charge sum and compare circuit 404 shown in FIG. 14. The output pulse signals C-tl′ . . . . C-br′ are connected to respective inverters 420, which each provide an output to a respective capacitor 422. A capacitor array 423 is discharged to a threshold level. If enough of the pulses output by the delay circuits 402 charge the respective capacitors 422 to overcome the threshold level of the capacitor 423, a comparator circuit 424 will flip and output a correlation signal to the decide logic circuit 406.

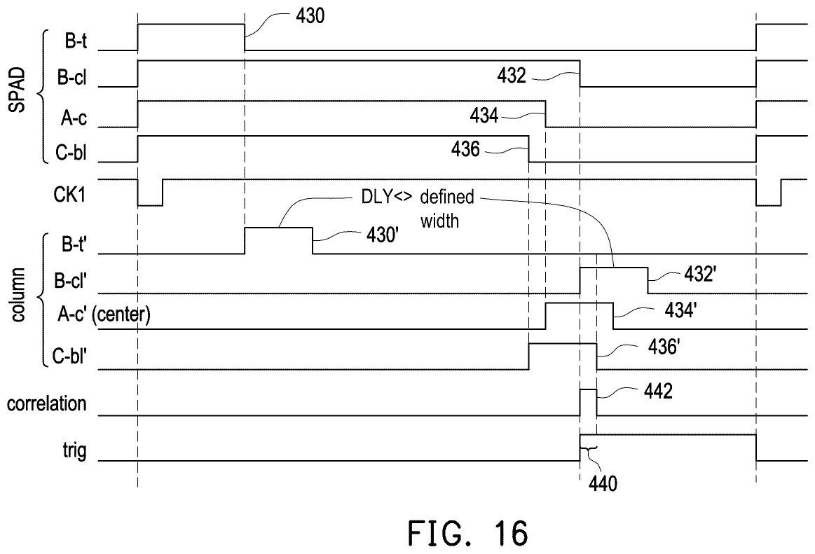

FIG. 16 is a timing diagram illustrating an example of the operation of the charge sum and compare circuit 404. FIG. 16 shows triggering events for four of the SPADs 102 of the pixels B-t, B-cl, A-c and C-bl. When these pixels trigger, the delay circuit turns the triggering event into a pulse. Thus, when the pixel B-t triggers (i.e. at falling edge 430), the delay circuit 402 outputs a pulse 402′ having a predetermined pulse width. Similarly, when the pixels B-cl, A-c and C-bl trigger (i.e. at falling edges 432, 434 and 436), the delay circuits 402 output corresponding pulses 432′, 434′ and 436′. The pulses 432′, 434′ and 436′ overlap during a time period 440, which results in the charges exceeding the charge threshold to output a correlation pulse 442. The threshold charge capacitor(s) 423 can be adjusted as necessary to realize the desired charge sum for outputting the correlation signal.

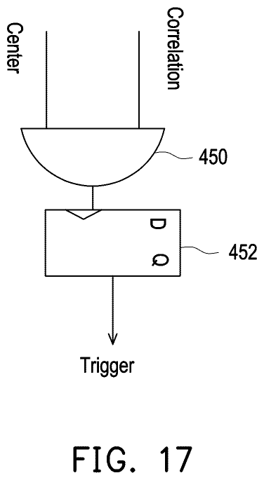

FIG. 17 illustrates an example of the decide logic circuit 406, which includes an AND gate 450 and a flip flop 452. The center pixel pulse signal A-c′ output by the delay circuit 402 and the correlation signal are input to the AND gate 450. As shown in FIG. 16, the center pixel A-c of the matrix 21 and the correlation signal are both high in the illustrated example. Thus the decide logic circuit would provide a high output to the flip flop 452, would accordingly output a high trigger signal to the TDC circuit 410 for the ToF determination. As noted above, the threshold charge capacitor(s) 423 can be adjusted as necessary to realize the desired charge sum for outputting the correlation signal. For example, if it is determined that more than three pixels need to fire to obtain the desired correlation, the threshold charge can be increased. Still further, the threshold charge capacitor(s) 423, as well as other factors since the delay parameter DLY< > may be adjusted in response to the captured 2D image, such as by AI.

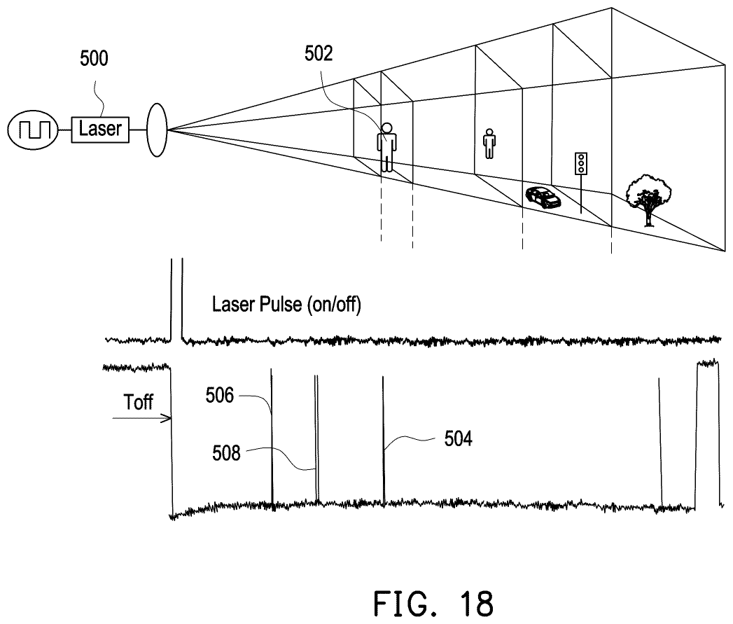

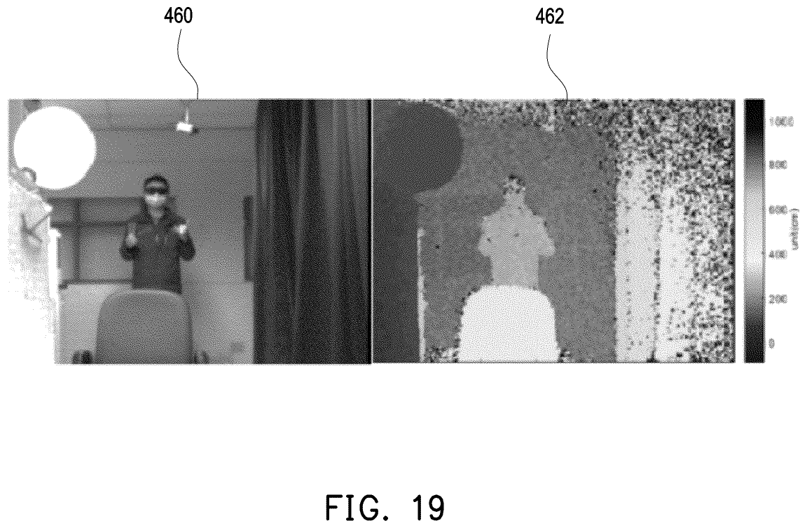

In some examples, the 3D ToF process supports multi-event sensing. As noted previously, thermally-generated carriers can fire the avalanche process in the SPAD pixels. Such dark noise and other noise such as ambient light can also interfere with photon timing for 3D imaging. Multi-event sensing further addresses issues associated with dark noise and other noise. FIGS. 18 and 19 conceptually illustrate such multi-event sensing. FIG. 18 illustrates a light source 500 associated with a pixel 110, such as a laser. The light source 500 emits a light pulse towards an identified target object such as a person 502. When photons from the light reflected by the target reach the SPAD 102 of the pixel 110, a trigger signal 504 is output.

However, in some instances, dark noise or other noise can cause the SPAD to trigger independently of detecting photons reflected by the target 502, resulting in a trigger signal 506 and/or 508 prior to the trigger signal 504. By configuring the 3D data path 132 for a multi-event operation of the pixels 110, each of the trigger events 504, 506 and 508 can be detected. The correlation process discussed above can then be used to determine which of the trigger signals 504, 506 and 508 is associated with the target 502.

As noted above in conjunction with FIGS. 10-13, disclosed examples provide a full image frame that includes a 2D image based on pulses output by the SPAD 102 and counted by the counter circuit 310 based on detected photons. FIG. 19 illustrates an example of such a 2D image 460 based on the 2D counter 310 for all rows of the image except the selected 3D target row(s) 174b (see FIG. 5). FIG. 19 further shows a 3D depth image 462 corresponding to the 2D image 460. In disclosed embodiments, the 3D information would be collected only for an identified target in the 2D image, such as the 3D target area 174a or the 3D target row(s) 174b shown in FIG. 5. Referring again to FIG. 18, to address issues related to dark count and ambient light, a laser pulse from the light source 500 is reflected from the person 502, which corresponds with the pulse 504.

Pulses 506 and 508 result from ambient light or dark count errors. If there were no issues with ambient light or dark count, the pulses 506 and 508 would not exist and the TDC circuit would be able to accurately determine ToF info based on the pulse 504. However, in the example of FIG. 18, Ambient light and/or dark count errors caused the pulses 506 and 508. The circuit 400 of FIG. 14 includes the charge sum and compare circuits 404, which are configured to identify pulses such as the pulses 506 and 508 and disregard them, since they do not result from being reflected by a legitimate target subject 502. More particularly, referring again to FIG. 14, since the pulses 506 and 508 are random pulses generated by ambient light or dark count events, an insignificant number of adjacent pixels 110 of the matrix 21 would trigger in addition to the center pixel A-c of the matrix 21 to correlate or verify the center pixel's A-c output. Thus, the pulses 506 and 508 would not trigger the TDC circuit 410. Note that this determination typically is made based on several (e.g. 100 or more) cycles to establish a histogram and confirm the pulse 504.

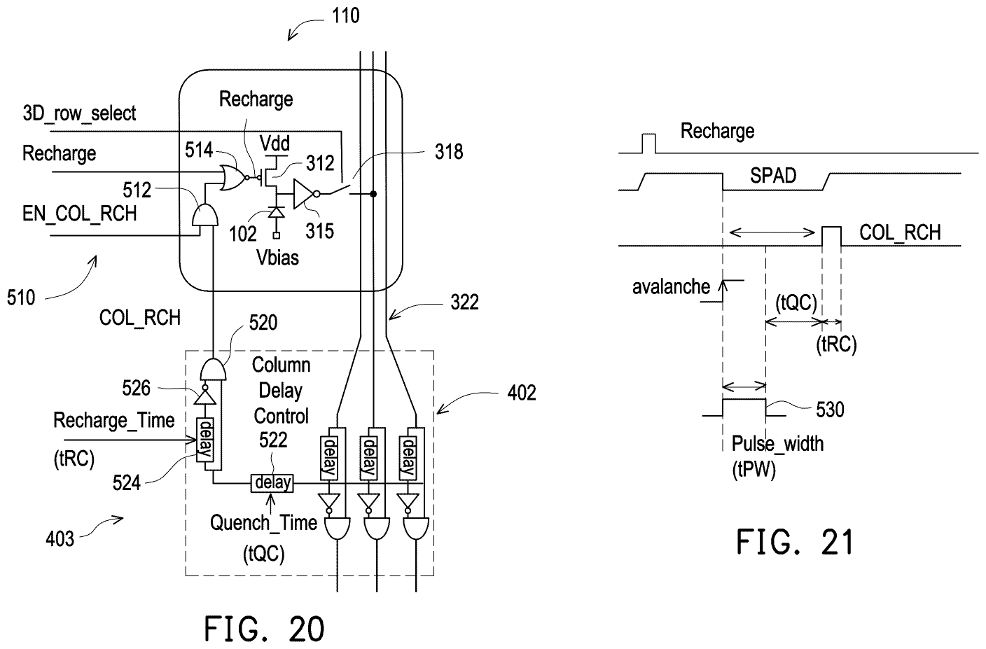

In order for the SPAD 102 of the pixels 110 to detect the photons associated with the target 502 subsequent to a noise-generated trigger 506 or 508, the SPAD needs to be recharged. FIG. 20 illustrates an embodiment of the pixel 110 and delay circuit 402 configured for this purpose. In the pixel 110 shown in FIG. 20, the control transistor 312 is connected between the cathode of the SPAD 102 and the first voltage terminal Vdd. An anode of the SPAD 102 is connected to the bias terminal Vbias. In the example of FIG. 20, the control transistor 312 is a PMOS transistor. The cathode of the SPAD 102 is further connected to an input of an inverter 315, and the output of the inverter 315 is connected to the row select switch 318.

The pixel 110 of FIG. 20 includes a recharge circuit 510 having an AND gate 512 and a NOR gate 514. The NOR gate 514 outputs the Recharge control signal to the gate of the control transistor 312. In addition to defining a pulse for the SPAD trigger signal, the delay circuit 402 shown in FIG. 20 is configured to output a column recharge signal COL_RCH based on a quench time tQC and a recharge time tRC. The delay circuit 402 outputs a recharge delay circuit 403 that outputs a quench delay signal 522 based on the quench delay time tQC to an AND gate 520. A recharge delay signal 524 based on the recharge time tRC is also output to the AND gate 520 through an inverter 526. The recharge circuit 510 and recharge delay circuit 403 are shown for only the 3D data bus 322 for the center column in FIG. 20 for simplicity. In some actual implementations, each 3D bus 322 has a recharge circuit 510 and recharge delay circuit 403 associated therewith.

FIG. 21 is a timing diagram illustrating an example of operation of the delay circuit 402 and recharge circuit 510 shown in FIG. 20. The Recharge signal shown in FIG. 21 is for the initial recharge of the SPAD, causing the SPAD to charge to a high level. When the SPAD triggers (goes into avalanche mode) the SPAD output goes low. As discussed in conjunction with FIG. 15 and FIG. 16, the delay circuit 402 creates a pulse signal 530 based on the SPAD trigger (e.g. pulses 430′, 432′, 434′, 436′ shown in FIG. 16). The column recharge signal COL_RCH goes high following the quench delay time tQC for the duration of the recharge delay time tRC. If the column recharge enable signal EN_COL_RCH is also high, the SPAD recharges.

Thus, as noted above, the delay circuits 402 shown in FIG. 20 are configured to turn the triggering event of the SPADs 102 (i.e. avalanche mode) into a pulse. These pulses are output to the charge sum and compare circuits 404 of FIG. 14. The delay circuits 402 can therefore adjust the trigger pulse width (e.g. widen the pulse), resulting in better correlation of the SPADs signal by the charge sum and compare circuits 404. Moreover, the delay circuits 402 further are configured to provide the recharge delay signals 522, 524 to delay the recharge signal output to control transistor 312 of the pixel control circuit 300. This operates to better disregard random pulses generated by ambient light and dark count errors, such as the pulses 506 and 508 of FIG. 18.

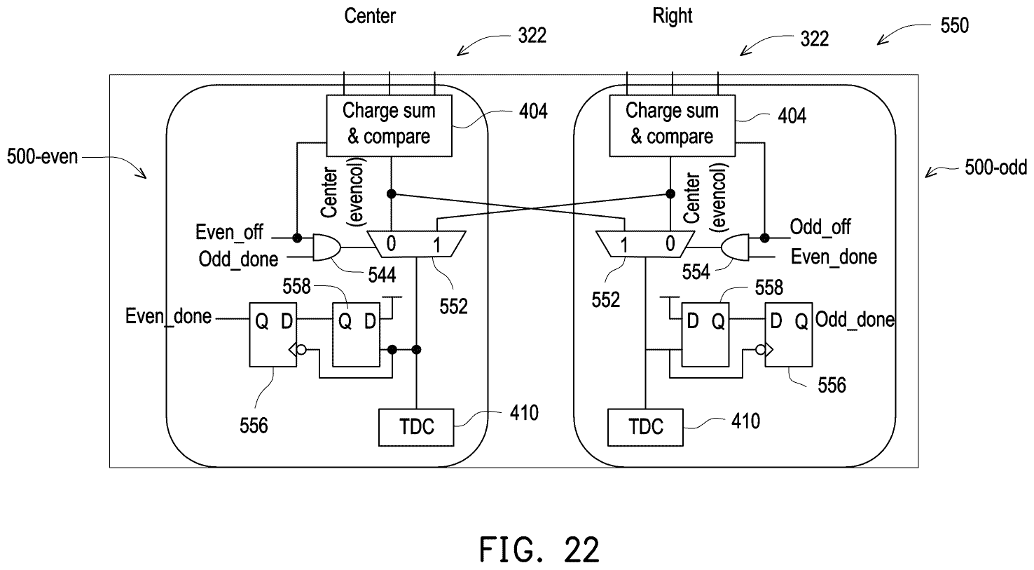

FIG. 22 illustrates an example of an even/odd TDC assist circuit 550 configured to facilitate multi-event operation. If multiple SPAD events are processed, additional TDC circuits are used to process the column recharged multi-events from the same correlator. To avoid additional circuit structures for this purpose and leverage the idle (i.e. unused) TDC circuits on the non-IR columns of RGB-IR pixel configuration, disclosed examples employ circuits of an adjacent column. For example, FIG. 22 shows an odd TDC assist circuit 550-odd on the right side of the drawing, connected to the 3D data bus of the right column shown in FIG. 14. An even TDC assist circuit 550-even is on the left side of the drawing, connected to the 3D data bus of the center column of FIG. 14. Each of the assist circuits 550 includes a MUX 552 receiving a control input from an AND gate 554. Each of the assist circuits 550 further includes flip flops 556 and 558.

For multi-event operation, the odd assist circuit 550-odd can be configured to provide SPAD sensing output for a second SPAD event. If the odd column (i.e. right column) is in assist mode, the Odd_off signal is asserted to turn off to block the SPAD output from being received by the associated charge sum and compare circuit 404. Instead, a second SPAD trigger event of the center column is output to the charge sum and compare circuit of the odd assist circuit 550-odd. The Odd_off signal is also input to the AND gate 554 of the odd assist circuit 550-odd.

When the charge sum and compare circuit 404 of the even bus (i.e. center) receives a SPAD trigger signal from the center column and thus provides a high output to enable the TDC circuit 410, the output of the charge sum and compare circuit 404 is also received by the flip flops 556 and 558, resulting in outputting the Even_done signal, indicating the first SPAD event for the center column is complete (i.e., TDC circuit 410 has been triggered). The even_done signal is also input to the AND gate 554 of the odd assist circuit 550-odd. This causes the AND gate 554 to output a high control signal to the MUX 552 of the odd assist circuit 550-odd, switching the MUX 552 of the odd assist circuit 550-odd to provide the output of the even charge sum and compare circuit 404. Thus, the second SPAD event of the even (center) column will be output to the TDC 410 of the odd assist circuit 550-odd. Using the even/odd assist circuits allows use of a TDC circuit 410 configured for single SPAD events for multi-event operation. Moreover, the use of the correlation circuit of FIG. 14 together with the multi-event circuits shown in FIG. 22 provides improved noise and ambient light immunity of 3D ToF measurements.

If the even/odd column TDC circuits 410 are not used for multi-event processing, other embodiments use the idle TDC circuits for ambient light calibration. As noted above in conjunction with FIG. 3, the IR filter 104 is used for photon detection for the ToF calculations used in 3D imaging. Thus, in the 3D mode (i.e. 3D_row_select signal asserted) only the IR pixel 110 is used. Accordingly, only TDC circuits 410 of columns having IR pixels are used. In this situation, RGB pixels in adjacent columns may be used for calibration of the IR pixels, even though the RGB pixels do not include the IR filter for detecting the reflected IR light used for 3D imaging. For instance, ambient light detected by the RBG pixels (i.e. the 2D pixels) can be used to “subtract” ambient light detected by the IR pixels, thus removing noise from the 3D image data.

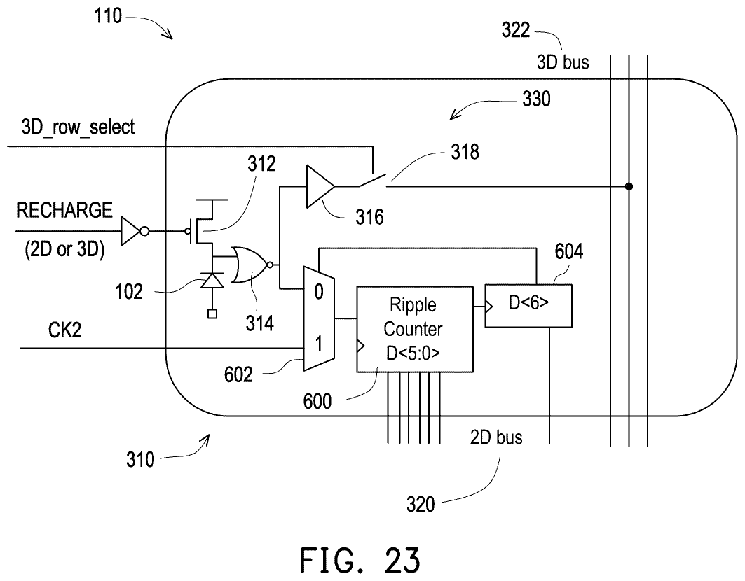

FIG. 23 illustrates an example of a high dynamic range counter used in the 2D data path 122 for 2D imaging. As noted previously, 2D images created by the sensing system 10 are based on the SPADs detecting photons of light and counting the photons. FIG. 23 shows an embodiment of the pixel 110 where the counter 310 is a high dynamic range counter.

In low light situations, fewer photons will be received by the SPADs 102. Conversely, in strong light conditions, more photons will be received by the SPADs. Thus, in low light conditions, a smaller counter circuit could be employed. A smaller counter circuit may be desirable to reduce the overall size of the pixel 110. The 2D portion of the pixel 110 of FIG. 23 includes a counter circuit 310 that has a six bit ripple counter circuit 600, a MUX 602 and a memory such as a register or flip flop 604.

In low light situations, (e.g. photon count is less than 64), the six bit counter 600 operates in a conventional manner, simply counting the number of photons received by the SPAD 102. In this case, the memory 604 stores a 0, since the counter 600 is not “full,” which also represents a 0 value for the MSB of the counter circuit 310. This MSB value is output to the 2D bus 320, and also to the control input of the MUX 602.

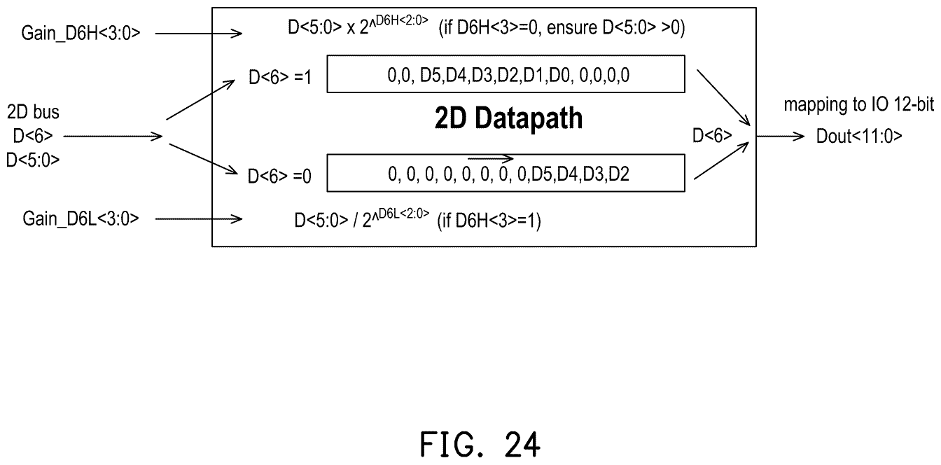

In strong light conditions, the six bit counter 600 quickly exceeds 63 (i.e. 111111) causing the memory 604 to go to 1 and automatically reset the counter 600 (i.e. 000000). This, in turn, causes the MUX 602 to output the slow clock signal CK2. The six bit counter 600 now counts slower CK2 pulses which represents how quickly the counter over-flows. Since CK2 is a slow clock as compared with the strong light-generated high frequency pulses, the dynamic range is extended and power consumption is reduced by reducing the size or number of counters and the SPAD toggling in the strong light conditions. FIG. 24 illustrates application of gain factors based on the value of D<6> of the memory 604 to map the counter to a 12 bit output by selectively shifting counter bits. In some examples, the 2D image processor 120 is configured for such data shift operations. The MSB of Gain_D6x<3:0> is subject to a multiply operation if D6x<3>=0, or a divide operation if D6x<3>=1, by 2^{D6x<2:0>}.

Thus, if D<6>=0, bits are right shifted according to D<5:0>/2^{D6L<2:0>}. If D<6>=1, bits are left shifted according to D<5:0>×2^{D6H<2:0>} (if D6H<3>=0, insure D<5:0>>0). If additional layout area is available, other embodiments use two counters rather than the memory 604. The counter 600 can be used for photon counting in low light situations and in strong light situations a second counter is provided for CK2 counting to provide additional counter bits by combining the two counters.

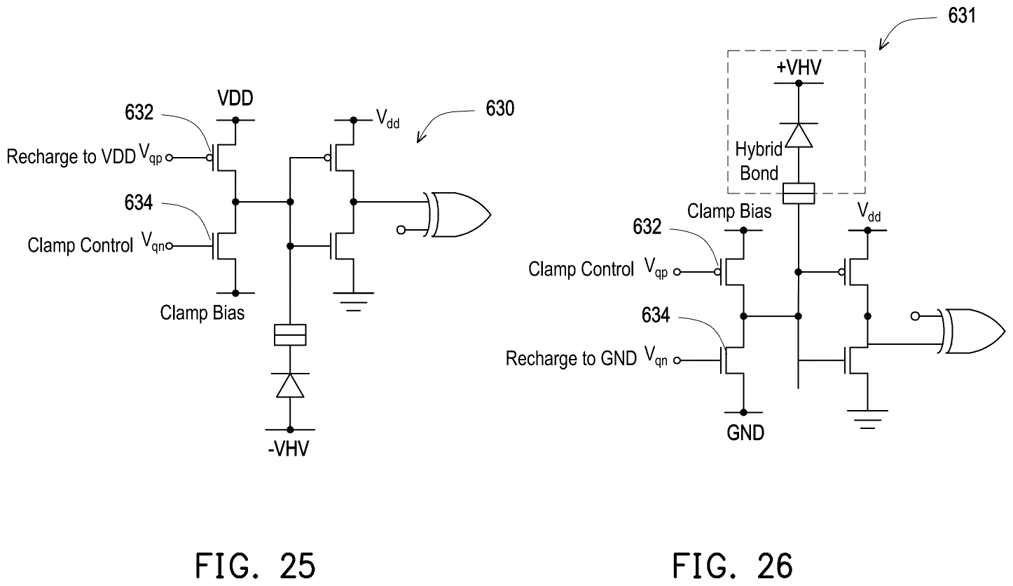

In some embodiments, the pixel 110 also includes a clamping circuit. Referring back to FIG. 10, the SPAD 102 of the pixel 110 is recharged to the Vdd voltage level, but the Vbias voltage level at the anode terminal of the SPAD 102 is typically set to a value that results in the SPAD being pulled to a very low voltage level on average. In some instances, this could damage associated logic circuits, such as the NOR gate 314. FIGS. 25 and 26 illustrate respective clamping circuits 630 and 631 including a PMOS transistor 632 and an NMOS transistor 634 connected in series between a clamp bias voltage terminal and Vdd (FIG. 25) or ground (FIG. 26). The clamp control signals cause a predetermined current flow to prevent the SPAD from being pulled extremely low (FIG. 25) or extremely high (FIG. 26). The circuits illustrated in FIG. 25 and FIG. 26 are essentially the same structure with only the voltage terminals (Vdd/ground) swapped with XOR gate polarity change. These circuits thus can serve SPADs with positive VHV or negative-VHV and increases usable devices by allowing a smaller gate-oxide MOS.

Disclosed embodiments thus provide an imaging system that uses a 4D, 2D, 3D imaging flow in which 3D imaging data is obtained only for a target area or row. In other words, some examples insert 3D image data associated with the target area (as opposed to 3D image data for the entire image frame) into a 2D image frame. The 4D/2D image is used to determine the target area for 3D data capture. A gated SPAD pixel arrangement facilitates such imaging. Further, a SPAD array architecture is provided that outputs a full frame 2D photon counting image and regional 3D ToF simultaneously leveraging a RGB-IR color filter. A compact unit pixel HDR counter with a global shutter 2D image is accumulated from high frame rate 4D data which can help to track object movement to deblur and help to identify a 3D region to increase the overall system response. An AI attention engine based on the 2D scene is used to optimize the parameters of the 3D ToF circuit by the combination of correlation and multi-event circuits.

In accordance with some disclosed embodiments, a pixel includes a SPAD, a counter circuit configured to selectively count pulses output by the SPAD based on detected photons in response to a recharge signal, and a row select circuit configured to selectively connect the SPAD to a time-to-digital (TDC) circuit in response to the recharge signal and a row select signal.

In accordance with further disclosed aspects, an image sensing method includes capturing a 2D image by a sensing array of a sensing device. The sensing array includes a plurality of SPADs. An object in the 2D image is detected by the sending array. Based on the detected object, a target in the 2D image is detected. A light pulse is emitted toward the target by a light source of the sensing device. Photons reflected back from the target are detected by the sensing array of the sensing device, and a time-of-flight (ToF) value of the detected photons is detected. A distance between the sensing array of the sensing device and the target is determined based on the determined ToF value.

In accordance with still further disclosed aspects, an image sensor system includes an array of pixels arranged in rows and columns. Each of the pixels includes a SPAD, a counter circuit configured to selectively count pulses output by the SPAD based on detected photons in response to a recharge signal. An output of the counter circuit is connected to a 2D data bus. A row select circuit is configured to selectively connect the SPAD to a 3D data bus in response to a row select signal. A 2D image processor is connected to the 2D bus, and a 3D image processor is connected to the 3D bus. The 3D image processor includes a TDC circuit. An image controller is connected to the 2D image processor and the 3D image processor. The 2D image processor includes a row control circuit configured to output the row select signal.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A pixel, comprising:
a single photon avalanche detector (SPAD);
a counter circuit configured to selectively count pulses output by the SPAD based on detected photons in response to a recharge signal; and
a row select circuit configured to selectively connect the SPAD to a time-to-digital (TDC) circuit in response to the recharge and a row select signal.

2. The pixel of claim 1, further comprising a color filter over the SPAD.

3. The pixel of claim 2, wherein the color filter includes an infrared (IR) filter.

4. The pixel of claim 1, further comprising:
a control transistor connected between a first terminal of the SPAD and a first voltage terminal, a gate terminal of the control transistor configured to receive the recharge signal;
a buffer circuit having an input terminal connected to the first terminal of the SPAD; and
wherein the row select circuit includes a row select switch configured selectively connect an output terminal of the buffer circuit to a 3D data bus in response to the row select signal.

5. The pixel of claim 4, wherein the buffer circuit comprises an inverter.

6. The pixel of claim 1, wherein the counter circuit is configured to count the pulses output by the SPAD a first clock speed or a second clock speed faster than the first clock speed based on a most significant bit (MSB) of the counter.

7. The pixel of claim 6, wherein the counter circuit includes a first counter configured to count the pulses output by the SPAD at the first clock speed and a second counter configured to count the pulses output by the SPAD at a second clock speed slower than the first clock speed.

8. The pixel of claim 1, further comprising a light source, wherein SPAD is configured detect photons of light emitted by the light source and reflected by a target.

9. The pixel of claim 8, wherein the light source is configured to emit infrared (IR) light.

10. The pixel of claim 1, further comprising a recharge circuit configured to recharge the pixel after a predetermined quench time delay.

11. A method, comprising:
capturing a 2D image by a sensing array of a sensing device, wherein the sensing array includes a plurality of single photon avalanche diodes (SPAD);
detecting an object in the 2D image;
based on the detected object, identifying a target in the 2D image;
emitting a light pulse toward the target by a light source of the sensing device;
detecting photons reflected back from the target by the sensing array of the sensing device;
determining a time-of-flight (ToF) value of the detected photons; and
calculating a distance between the sensing array of the sensing device and the target based on the determined ToF value.

12. The method of claim 11, further comprising:
capturing a 4D image at a first frame rate;
extracting motion from the 4D image; and
wherein the 2D image is captured at a second frame rate lower than the first frame rate.

13. The method of claim 11, wherein the target is a target row of the array.

14. The method of claim 13, further comprising generating a full frame output for the target row, including:
generating a plurality of imaging cycles;
integrating 2D imaging data in each of the plurality of imaging cycles; and
determining ToF value of the detected photons of the target row in each of the plurality of imaging cycles.

15. The method of claim 14, further comprising:
constructing a histogram based on the determined ToF values.

16. The method of claim 11, further comprising:
generating a first pulse by a first delay circuit connected to a first SPAD of the plurality of SPADs in response to the first SPAD detecting photons;
adding the first pulse generated by the first delay circuit and a second pulse generated by a second delay circuit connected to a second SPAD of the plurality of SPADs adjacent to the first SPAD; and
comparing the added first and second pulses to a threshold charge.

17. An image sensor system, comprising:
an array of pixels arranged in rows and columns, each of the pixels comprising:
a single photon avalanche detector (SPAD);
a counter circuit configured to selectively count pulses output by the SPAD based on detected photons in response to a recharge signal, an output of the counter circuit connected to a 2D data bus;
a row select circuit configured to selectively connect the SPAD to a 3D data bus in response to a row select signal;
a 2D image processor connected to the 2D bus;
a 3D image processor connected to the 3D bus and including a time-to-digital (TDC) circuit; and
an image controller connected to the 2D image processor and the 3D image processor, the 2D image processor including a row control circuit configured to output the row select signal.

18. The image sensor system of claim 17, further comprising a plurality of delay circuits, each of the delay circuits connected to a respective one of the pixels, each of the delay circuits configured to generate a pulse having a predetermined pulse width in response to an output of the SPAD of the respective pixel.

19. The image sensor system of claim 18, further comprising a plurality of charge sum and compare circuits, each of the charge sum and compare circuits connected to a respective one of the delay circuits, each of the charge sum and compare circuits comprising:
a first capacitor connected to receive a first pulse output by the respective delay circuit;
a second capacitor connected to receive a second pulse output by an adjacent delay circuit;
a threshold capacitor charged to a predetermined threshold charge and connected to an output node of the first and second capacitors;
a comparator connected to the output node; and
a decide logic circuit configured to connect the respective pixel to the TDC circuit in response to the comparator.

20. The image sensor system of claim 18, further comprising a plurality of quench circuits, each of the quench circuits connected to a respective one of the delay circuits, each of the quench circuits comprising:
a first delay circuit configured to output a first delay signal based on a predetermined quench time;
a second delay circuit configured to output a second delay signal based on a predetermined recharge time; and
a logic circuit configured to output a recharge signal in response to the first and second delay circuits;
wherein the SPAD enable signal is output in response to the recharge signal.
